(19) United States
(12) Patent Application Publication
(10) Pub. No.: US 2004/0198431 A1
(43) Pub. Date: Oct. 7, 2004

(54) Mobile telephone with priority control function

(75) Inventors: Norikazu Yamagishi, Yokohama-shi (JP); Takaaki Habara, Yokohama-shi (JP); Mutsuhara Takesada, Yokohama-shi (JP)

Correspondence Address: Christopher J. Fildes, Fildes & Outland, P.C., 20916 Mack Avenue, Suite 2, Grosse Pointe Woods, MI, 48236, US

(73) Assignee: Hitachi Electronic Service Co., Ltd.

(21) Appl. No.: 10/279,148

(22) Filed: Oct. 23, 2002

(30) Foreign Application Priority Data
Jun. 11, 2002 (JP) 2002-170100

(51) Int. Cl. H04M 3/00; H04M 1/00; H04B 1/38

(52) U.S. Cl. 455/556.1; 455/418

(57) ABSTRACT

The mobile telephone with plural functions including a calling function comprises an overall control unit 110, a transmission-reception control unit 120, a line occupancy priority control unit 130 including a priority designation operation control unit 132, an input unit 140 including a function priority order setup unit 142, a display 150, a memory 160, and a power control unit 170, said mobile telephone further comprising a function to prioritize the operation of a selected function over the other functions.

### FIELD OF THE INVENTION

The present invention relates to a mobile telephone with a priority control function including a function to prioritize the execution of a designated function over other functions.

### DESCRIPTION OF THE RELATED ART

In recent days, mobile telephones are provided with various functions in addition to the essential calling function.

The present invention aims at providing a mobile telephone with a priority control function enabling the user to designate in advance priority orders to the plural functions of the mobile telephone, thereby prioritizing the execution of a function having a higher priority order over the other functions when a function interrupts a currently executed function in the mobile telephone.

### SUMMARY OF THE INVENTION

In order to achieve the above object, the mobile telephone according to the present invention comprises an overall control unit; a transmission-reception control unit; a line occupancy priority control unit including a priority designation operation control unit; an input unit including a function priority order setup unit; a display; a memory; a power control unit; and a function to prioritize the operation of a selected function over the other functions.

Further, the present mobile telephone comprises a position detecting unit for detecting the current position; said input unit including a destination and passage point setup unit and an addressee telephone number and mail address setup unit for notifying the arrival at the designated locations; and an addressee telephone number and mail address transmission control unit.

Even further, the present mobile telephone comprises a function to set one or more functions that are to be prioritized.

Moreover, the present mobile telephone comprises a function to put the operation of a currently executed function on hold so as to prioritize the operation of an interrupting function when an interruption by a function with higher priority occurs when a selected function is being executed.

Furthermore, the mobile telephone comprises a function to execute the function having a lower priority in continuation after the ongoing function is put on hold or terminated.

Moreover, the mobile telephone comprises a function to put the operation of a function on hold until the operation of the function having a higher priority is either put on hold or terminated upon the occurrence of an interruption by a function having a lower priority than the selected function.

Even further, the mobile telephone comprises a function to interrupt the currently executed function by putting the operation thereof on hold.

Further, the mobile telephone comprises a function to output a warning or a message indicating that the operation of the function having a lower priority is put on hold.

According to another aspect of the invention, the mobile telephone comprises a function to output a warning or a message indicating that an interruption having higher priority has occurred.

### BRIEF DESCRIPTION OF THE DRAWINGS

FIG. 1 is a block diagram showing the configuration of a mobile telephone according to embodiment 1;

FIG. 2 illustrates a screen of the function priority select menu; and

FIG. 3 is a process flowchart of function priority control.

### DETAILED DESCRIPTION OF THE PREFERRED EMBODIMENT

The preferred embodiment of the present invention will now be explained with reference to the accompanying drawings.

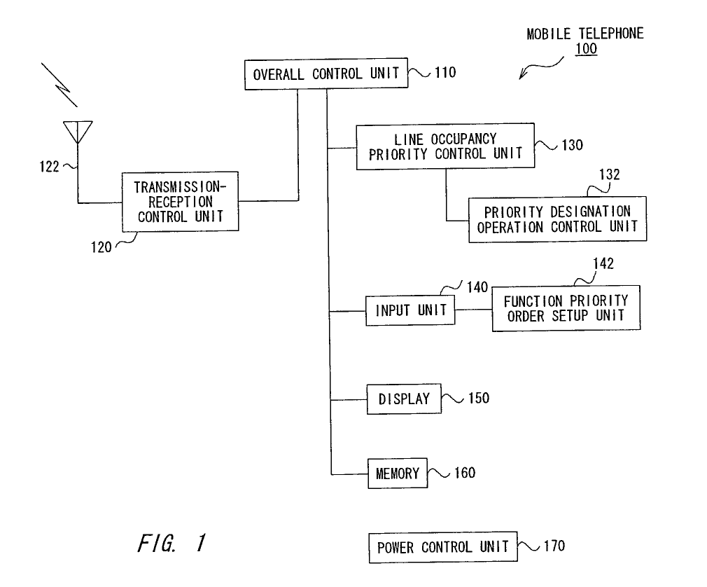

FIG. 1 is a block diagram illustrating the configuration of the mobile telephone according to embodiment 1.

A mobile telephone 100 comprises an overall control unit 110, a transmission-reception control unit 120 enabling communication with the exterior via an antenna 122, a line occupancy priority control unit 130 equipped with a priority designation operation control unit 132, an input unit 140 equipped with a function priority order setup unit 142, a display 150 capable of displaying a function priority select menu, a memory 160 storing for example the function priority order being set, and a power control unit 170 for controlling the supply of power necessary for the whole mobile telephone. The mobile telephone 100 has the following functions: to set up one or more functions that are to be prioritized; to put the function in execution on hold so as to prioritize the execution of the interrupting function when an interruption by a function with higher priority occurs while a selected function is being executed; to execute the function with lower priority continuously when the operating function is either interrupted or terminated; to put the interruption on hold until the function with higher priority is either ordered to wait or terminated when an interruption of a function with lower priority than the selected function occurs; to put a function on hold by interruption; to output a warning or message notifying that the operation of a function with lower priority is put on hold; and to output a warning or message notifying the occurrence of an interruption with higher priority.

Though not shown in the drawings, a mobile telephone according to embodiment 2 of the present invention comprises in addition to the configuration of the mobile telephone of embodiment 1 a position detector for detecting the current position by GPS, a destination and passage point setup unit and an addressee telephone number and mail address setup unit provided to the input unit 140 in correspondence with the position sensor for notifying the addressee that the telephone has reached these locations, and an addressee telephone number and mail address transmission control unit.

Both embodiments are designed to be able to output necessary warnings and other messages.

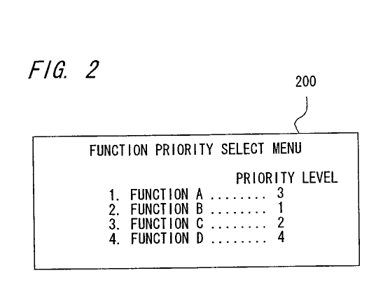

FIG. 2 shows a screen of a function priority select menu 200. This menu is displayed on the display 150 of the mobile telephone, enabling the user to designate the order of priority of each function. In the example in the menu illustrated in FIG. 2, the priority level of the functions are designated in the following order from high to low; function B, function C, function A and function D.

The functions can include, for example, “connecting call”, “receiving call”, “communicating”, “playing game” and “GPS” (“detecting location”). The owner of the mobile telephone displays the function priority select menu on the screen and designates the priority order of each function in advance.

According to this feature, when the owner of a mobile telephone according to embodiment 2 equipped with the position detector utilizes the function to automatically notify a designated addressee that he/she has arrived at the destination or at a passage point, if the function priority order is not set, the automatic transmission cannot be performed when the user reaches the designated location while a call is connected, but if the priority of the automatic transmission function is set to a level higher than the other functions, the mobile telephone will send out a warning when the user approaches a designated location while a call is connected, and when the user reaches the designated location, the mobile telephone interrupts the call and performs the automatic transmission. When the automatic transmission is terminated, the interrupted call is resumed.

If it is possible to utilize a call waiting service, a call will be interrupted for automatic transmission but can be resumed without delay.

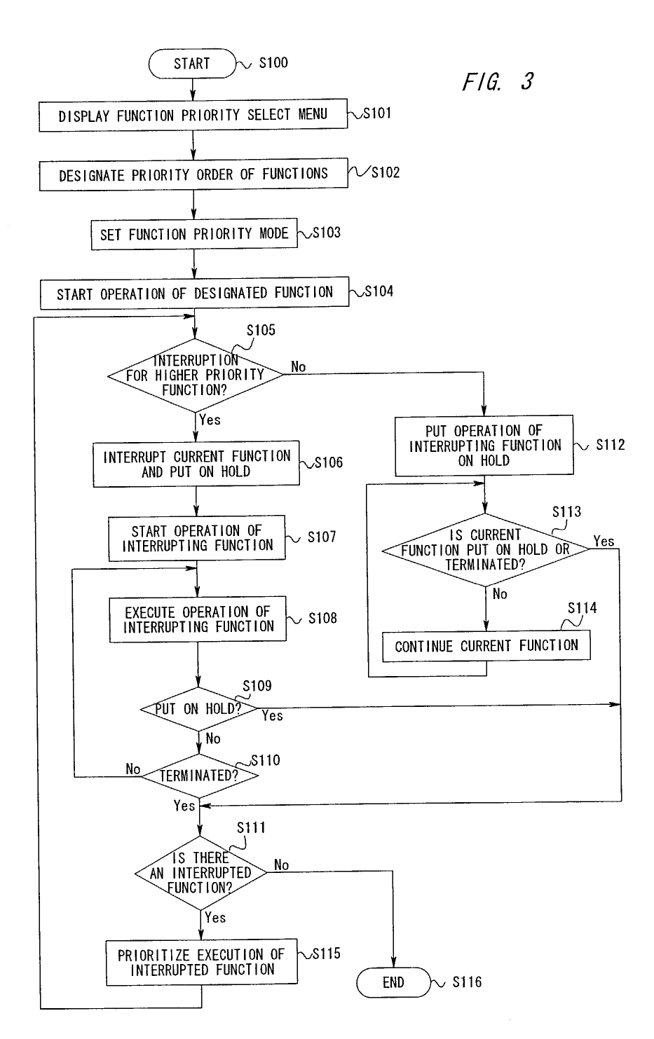

FIG. 3 is a process flow illustrating the function priority control.

The procedure starts at step S100, and in step S101, the function priority select menu, one example of which is illustrated in FIG. 2, is displayed on the screen. Then, in step S102, the priority order for each function is designated. If the function priority mode is selected in step S103, the designated function starts to operate (step S104).

When there occurs an interruption during an operation of the mobile telephone (such as during a call), step S105 checks whether this interruption is for a function having a higher priority or not, and if the interruption is of a higher priority function, the currently executed function is interrupted in step S106 and put on hold, and in step S107 the operation of the interrupting function is initiated to execute the interrupting function in step S108.

If according to the check of step S105 the interrupting function does not have a higher priority, then the procedure advances to step S112 to put the operation of the interrupting function on hold, then in step S113 it is confirmed whether or not the currently executed function is either put on hold or terminated, and if the current function is neither put on hold nor terminated, the procedure advances to step S114 where the currently executed function is continued, and the procedure returns to step S113. When the currently executed function is either put on hold or terminated, the procedure advances to step S111. Sequential to step S108, step S109 checks whether the interrupting function is on hold or not, and if the function is put on hold, the procedure advances to step S111, but if it is not on hold, the procedure advances to step S110 where whether the function is terminated or not is checked. If the function is terminated, the procedure advances to step S111 where whether an interrupted function exists or not is checked, and if there is an interrupted function, the interrupted function is resumed continuously, and the procedure returns to step S105. If according to the check performed in step S111 there is no interrupted function, the procedure advances to step S116 where the process is terminated.

As explained, the present invention allows the user to designate the priority of functions of the mobile telephone in advance, so that when an interruption occurs during the operation of a function, the priority of the interrupting function is checked, and the function designated to have a higher priority is executed with priority over the other functions.

What is claimed is:

1. A mobile telephone with a priority control function capable of performing plural functions including a calling function, said mobile telephone comprising:
an overall control unit;
a transmission-reception control unit;
a line occupancy priority control unit including a priority designation operation control unit;
an input unit including a function priority order setup unit;
a display;
a memory;
a power control unit; and
a function to prioritize the operation of a selected function over the other functions.

2. A mobile telephone with a priority control function according to claim 1, further comprising:
a position detecting unit for detecting the current position;
said input unit including a destination and passage point setup unit and an addressee telephone number and mail address setup unit for notifying the arrival at the designated locations; and
an addressee telephone number and mail address transmission control unit.

3. A mobile telephone with a priority control function according to claim 1, further comprising a function to set one or more functions that are to be prioritized.

4. A mobile telephone with a priority control function according to claim 1, further comprising a function to put the operation of a currently executed function on hold so as to prioritize the operation of an interrupting function when an interruption for a function with higher priority occurs when a selected function is being executed.

5. A mobile telephone with a priority control function according to claim 1, further comprising a function to put the operation of a currently executed function on hold so as to prioritize the operation of an interrupting function when an interruption for a function with higher priority occurs when a selected function is being executed, and a function to execute the function having a lower priority in continuation after the ongoing function is put on hold or terminated.

6. A mobile telephone with a priority control function according to claim 1, further comprising a function to put the operation of a function on hold until the operation of the function having a higher priority is either put on hold or terminated upon the occurrence of an interruption for a function having a lower priority than the selected function.

7. A mobile telephone with a priority control function according to claim 1, further comprising a function to put the operation of a currently executed function on hold so as to prioritize the operation of an interrupting function when an interruption for a function with higher priority occurs when a selected function is being executed, and a function to interrupt the currently executed function by putting the operation thereof on hold.

8. A mobile telephone with a priority control function according to claim 1, further comprising a function to put the operation of a function on hold until the operation of the function having a higher priority is either put on hold or terminated upon the occurrence of an interruption for a function having a lower priority than the selected function, and a function to output a warning or a message indicating that the operation of the function having a lower priority is put on hold.

9. A mobile telephone with a priority control function according to claim 1, further comprising a function to put the operation of a currently executed function on hold so as to prioritize the operation of an interrupting function when an interruption for a function with higher priority occurs when a selected function is being executed, and a function to output a warning or a message indicating that an interruption having higher priority has occurred.
